(19) United States
(12) Patent Application Publication
(10) Pub. No.: US 2005/0118000 A1
(43) Pub. Date: Jun. 2, 2005

(54) Treatment subject receiving vessel body, and treating system

(76) Inventors: Shigeru Kasai, Yamanashi (JP); Masahide Itoh, Yamanashi (JP); Shunro Nagasawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/505,168

(22) PCT Filed: Feb. 28, 2003
(86) PCT No.: PCT/JP03/02380

(30) Foreign Application Priority Data
Feb. 28, 2002 (JP) 2002054540

(51) Int. Cl. B65G 1/00

(52) U.S. Cl. 414/217

(57) ABSTRACT

A treatment subject receiving vessel body 72 comprises a portable vessel main body 92, a treatment subject support member 100 installed in the vessel main body and capable of supporting a plurality of treatment subjects W, a joint port 96 formed in one side surface of the vessel main body and communicating with the interior of the vessel main body, an openable/closable gate valve 94 installed in the joining port, and an exhaust port 108 made openable/closable to be capable of exhausting the vessel main body. When the gate valve and exhaust port are closed, the vessel main body is brought to the sealed state.

### FIELD OF THE INVENTION

The present invention relates to a treatment subject receiving vessel body for accommodating and transferring a treatment subject such as a semiconductor wafer or the like in a sealed state and to a treating system having multiple processing apparatuses.

### BACKGROUND OF THE INVENTION

In order to manufacture a semiconductor integrated circuit, various processes such as film forming, etching, oxidation and diffusion are performed on a wafer. Further, to be in line with the trend of miniaturization and high integration of semiconductor integrated circuit, and to improve the throughput and the yield, a processing apparatus designed as a so-called cluster tool has been disclosed, wherein multiple processing apparatuses performing a same process or otherwise performing different processes are connected with one another via a common transfer chamber such that various processes can be sequentially executed without exposing wafers to the atmosphere, in, e.g., Japanese Patent Laid-open Publication Nos. 2000-208589 and 2000-299367. Further, the assignee of the present invention also filed a patent application on an improved cluster tool type processing system apparatus (Patent Application No. 2001-060968).

FIG. 7 is a schematic diagram that illustrates an example of a treating system, which is in conventional cluster tool form. As shown in FIG. 7, a treating system 2 includes three processing apparatuses 4A, 4B and 4C; a first transfer chamber 6; two loadlock chambers 8A and 8B having a preheating or cooling device; a second transfer chamber 10; and two cassette chambers 12A and 12B.

The three processing apparatuses 4A to 4C are all connected to the first chamber 6. The two loadlock chambers 8A and 8B are interposed in parallel between the first and the second transfer chambers 6, 10. Further, the two cassette chambers 12A and 12B are connected to the second transfer chamber 10. Further, gate valves G, which can be opened and closed airtightly, are interposed between the chambers.

In the first and second transfer chambers 6 and 10, a first and second multi-joint transfer arms 14, 16 that are capable of bending, stretching and revolving are installed respectively. By using the first and second transfer arms 14, 16 for holding and transferring a semiconductor wafer W, the wafer W is transported. Further, installed in the second transfer chamber 10 is a position alignment mechanism 22 having a rotatable table 18 and an optical sensor 20. The position alignment mechanism 22 performs a position alignment by detecting orientation flats or notches of the wafer W by rotating the wafer W taken from the cassette chamber 12A or 12B.

In processing a semiconductor wafer W, first by the second transfer arm 16 of the second transfer chamber 10 maintained under atmospheric pressure in an N₂ atmosphere, a semiconductor wafer W not yet processed is unloaded from either one of the cassette chambers, e.g., the cassette C 12A, and then mounted on the rotatable table 18 of the position alignment mechanism 22 in the second transfer chamber 10. Further, while the rotatable table 18 performs position alignment by rotating, the transfer arm 16 stands by without moving. With respect to the period it takes for the position alignment, it is, for example, about 10 to 20 seconds. Once the position alignment is completed, the transfer arm 16, which has been standing by, holds the wafer W obtained after the position alignment and transports it into either one of the loadlock chambers, e.g., the loadlock chamber 8A. In the loadlock chamber 8A, the wafer is preheated as necessary. At the same time, the inside of the loadlock chamber 8A is vacuum pumped to a certain pressure level.

When such preheating operation is completed, a gate valve G is opened and, thus, the inside of the loadlock chamber 8A communicates with the inside of the first transfer chamber 6 which has been maintained at a vacuum state in advance. The preheated wafer W is transported into a certain processing apparatus, e.g., the processing apparatus 4A, by the first transfer arm 14 and then is subject to a certain process such as a film forming process for metal or insulating film or the like.

A processed semiconductor wafer W is returned to the earlier cassette C of, e.g., the cassette chamber 12A. With respect to the transporting route of the processed wafer W to be returned, for example, it includes another loadlock chamber 8B, where the wafer W is cooled to a certain temperature and thereafter is returned. Further, the processed wafer W can be subjected to the position alignment performed by the position alignment mechanism 22 as necessary, before it is housed by the cassette C.

### SUMMARY OF THE INVENTION

In line with the trend of high miniaturization, high integration, thinner film and increasing number of layers, the demand for various functions of an integrated circuit has been increasing. As a result, with respect to manufacturing semiconductor integrated circuits, there is a tendency to shift from a mass production of a small variety to a small-lot production of a large variety.

In this case, with respect to the cluster tool type treating system as illustrated in FIG. 7, the first transfer chamber 6 needs be expanded to a larger size in order to install more processing apparatuses, so that the system itself becomes considerably large. Further, with respect to the wafer size, since there has been a tendency to shift from 8 inches (200 mm) to a larger size of 300 mm, the size of the first transfer chamber 6 to which the processing apparatuses 4A to 4C are connected becomes one step larger.

The present invention has been developed to solve the aforementioned problematic issues effectively. It is, therefore, an object of the present invention to provide a treatment subject receiving vessel body capable of being carried and accommodating a plurality of treatment subjects in a hermetically sealed state.

It is another object of the present invention to provide a treating system using the treatment subject receiving vessel body.

The present invention provides a treatment subject receiving vessel body, including: a vessel main body capable of being carried; a treatment subject support member, disposed in the vessel main body, for supporting a plurality of treatment subjects; a joint port formed at one side surface of the vessel main body and communicating with an interior of the vessel main body; an openable and closable gate valve installed at the joint port; and an openable and closable exhaust port disposed in the vessel main body to exhaust the vessel main body, wherein the vessel main body becomes sealed airtight when the gate valve and the exhaust port are closed.

In accordance with the present invention, multiple treatment subjects can be accommodated in the vessel main body capable of being carried in a hermetically sealed state. The inside of the vessel main body can be maintained at a vacuum state or filled with an inactive gas atmosphere.

Preferably, the vessel main body includes an exhaust opening; a vacuum pump connected to an exhaust opening; and a backing space connected to an exhaust side of the vacuum pump, the exhaust port being installed at the backing space.

In this case, it is possible to maintain the inside of the vessel main body at a high vacuum level. Further, a pump power supply for operating the vacuum pump is preferably installed at the vessel main body.

Further, the present invention provides a treating system including: the treatment subject receiving vessel body described above; a first transport auxiliary chamber having at one side thereof a vessel body port to which the treatment subject receiving vessel body is connected and having therein a transport arm mechanism for transporting a treatment subject; a second transport auxiliary chamber having at one side thereof a vessel body port to which the treatment subject receiving vessel body is connected and having therein a transport arm mechanism for transporting the treatment subject; and a vessel body transfer unit for transporting the treatment subject receiving vessel body between the first transport auxiliary chamber and the second transport auxiliary chamber.

In accordance with the present invention, it is possible to transfer the treatment subject between the first transport auxiliary chamber and the second transport auxiliary chamber while the treatment subject is accommodated in the treatment subject receiving vessel body.

Preferably, a processing chamber for performing a process on the treatment subject is further provided, and wherein the second transport auxiliary chamber is located such that another side thereof is adjacent to the processing chamber and the transport arm mechanism therein is capable of transporting the treatment subject between the processing chamber and the treatment subject receiving vessel body.

Further, preferably, it is possible that a loading/unloading port, onto which a cassette vessel containing plural treatment subjects is placed, is further provided, and wherein the first transport auxiliary chamber is located such that another side thereof is adjacent to the loading/unloading port, and the transport arm mechanism therein transports the treatment subject between the cassette vessel and the treatment subject receiving vessel body.

Furthermore, it is preferable that a loading/unloading port onto which a cassette vessel containing plural treatment subjects is placed and a common transfer chamber installed adjacent to the loading/unloading port are further provided, wherein the first transport auxiliary chamber is located such that another side thereof is adjacent to the common transfer chamber and the transport arm mechanism therein transports the treatment subject between the cassette vessel and the treatment subject receiving vessel body. In this case, more preferably, the common transfer chamber includes a positioning mechanism for performing positioning of the treatment subject.

Further, desirably, the vessel body port of the first transport auxiliary chamber is provided with an openable and closable gate valve, and the vessel body port of the second transport auxiliary chamber is also provided with an openable and closable gate valve.

In this case, more preferably, the first transport auxiliary chamber is provided with a gas exhaust line; the second transport auxiliary chamber is also provided with a gas exhaust line; a port gas supply line and a port gas exhaust line are installed outside the gate valve of the vessel body port of the first transport auxiliary chamber; and a port gas supply line and a port gas exhaust line are also installed outside the gate valve of the vessel body port of the second transport auxiliary chamber.

More preferably, the first transport auxiliary chamber is provided with a gas supply line and the second transport auxiliary chamber is also provided with a gas supply line.

### BRIEF DESCRIPTION OF THE DRAWINGS

FIG. 1 is a schematic diagram illustrating a treating system for a treatment subject in accordance with a preferred embodiment of the present invention;

FIG. 2 shows a cross sectional view illustrating an exemplary treatment subject receiving vessel body connected to a first transport auxiliary chamber;

FIG. 3 provides a perspective view illustrating an example of a treatment subject receiving main body;

FIG. 4 shows a cross sectional view illustrating an example of a treatment subject receiving vessel body connected to a second transport auxiliary chamber;

FIG. 5 presents an example of a vessel body transfer unit;

FIG. 6 represents a modified example of a treatment subject receiving vessel body; and

FIG. 7 offers a schematic diagram illustrating a conventional treating system of a treatment subject.

### DETAILED DESCRIPTION OF THE PREFERRED EMBODIMENTS

Hereinafter, a preferred embodiment of a treatment subject receiving vessel body and a treating system of the present invention will be described in detail with reference to the accompanying drawings.

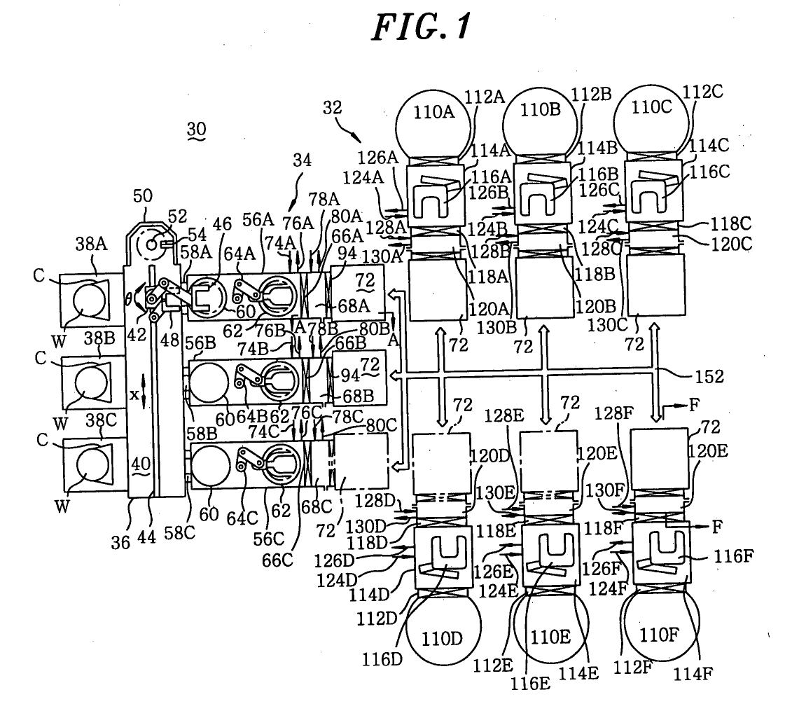

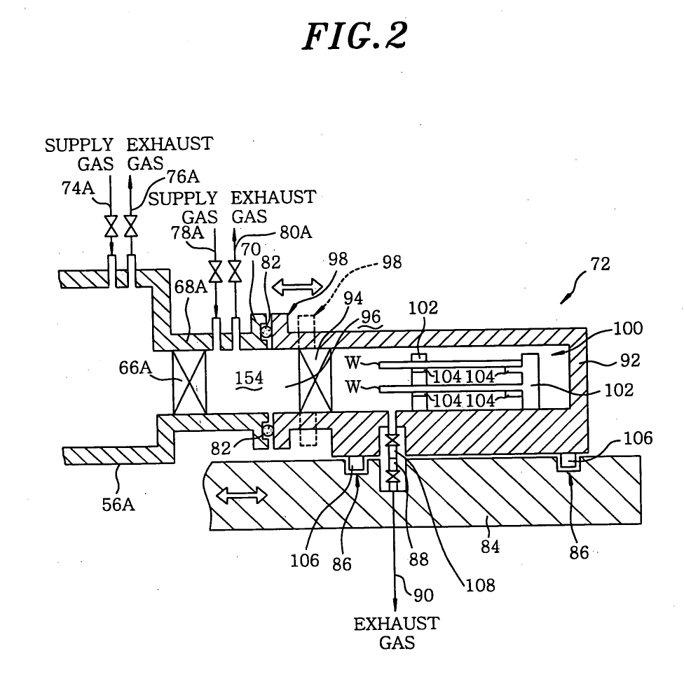

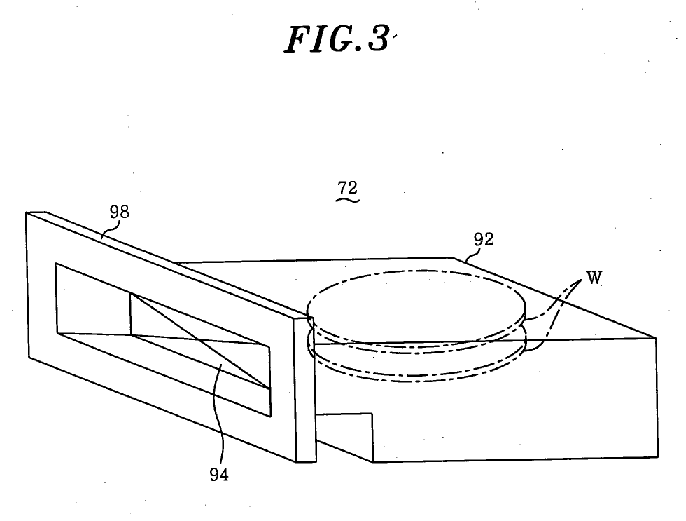

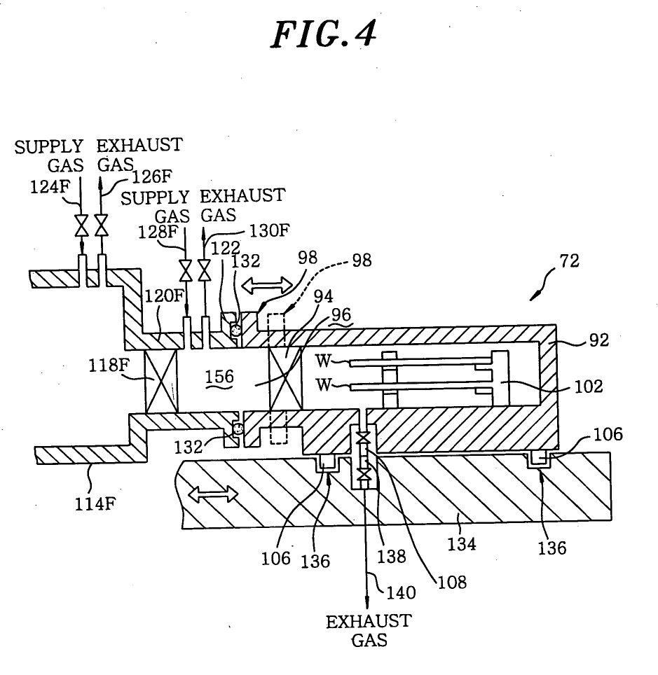

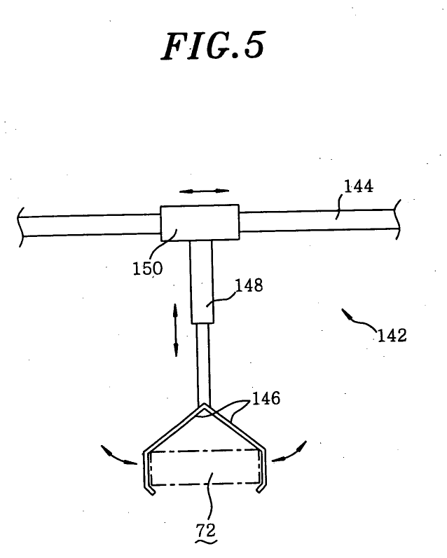

FIG. 1 is a schematic diagram illustrating a treating system of a treatment subject in accordance with a preferred embodiment of the present invention. FIG. 2 shows a cross sectional view illustrating an example of a treatment subject receiving vessel body linked with a first transport auxiliary chamber. FIG. 3 provides a perspective view illustrating an example of a treatment subject receiving main body. FIG. 4 shows a cross sectional view illustrating an example of a treatment subject receiving vessel body linked with a second transport auxiliary chamber. FIG. 5 shows an example of a vessel body transfer unit. Here, a semiconductor wafer is used as a treatment subject.

First, a treating system for processing a treatment subject will be described with reference to FIG. 1. A treating system 30 is composed of a processing unit 32 for performing various processes such as a film forming process, an etching process on a semiconductor wafer W as a treatment subject and a transfer unit 34 for loading and unloading the wafer W into and from the processing unit 32.

The transfer unit 34 has a common transfer chamber 36 formed of an elongated box body circulating clean air therein. Installed at one elongated side of the common transfer chamber 36 are cassette stages 38A, 38B and 38C serving as loading/unloading ports in which multiple (three in this example) cassette vessels C are disposed. Each of the cassette stages 38A, 38B and 38C is provided with a single cassette vessel C. Each of the cassette vessels C can accommodate therein, e.g., 25 wafers W at the maximum, while the wafers W being mounted in multiple stages having a same pitch therebetween. As for the cassette vessels C, it is acceptable to use a sealed structure vessel having its inside filled with an inactive gas, e.g., a N₂ gas atmosphere or the like, or an open structure vessel having its inside exposed to the atmosphere. In such manner, it is possible to load and unload the wafer into and from the common transfer chamber 36.

Installed in the common transfer chamber 36 is a common transfer mechanism 40 for transferring the wafer W along the length direction thereof (X direction). The common transfer mechanism 40 is fixed on a base 42. The base 42 is slidably supported on a guide rail 44 and is movable by a linear motor (not shown) or the like, while the guide rail 44 lies on the center line (X direction) of the common transfer chamber 36.

Further, the common transfer mechanism 40 has two multi-joint transfer arms 46, 48 disposed at upper and lower two stage positions. Each of the transfer arms 46, 48 is capable of contracting and extending in the R direction, i.e., from its center toward the radial direction. Further, the bending and stretching of each of the transfer arms 46, 48 can be separately controlled. Two-pronged forks are fastened to the front ends of the transfer arms 46, 48, respectively. Accordingly, the wafers W can be directly held on each of the forks.

Each rotation axis of the transfer arms 46, 48 is rotatably connected in a coaxial orientation to the base 42. Each rotation axis can rotate, e.g., in the θ direction, which is the revolving direction with respect to the base 42 as a unit.

Further, each rotation axis is movable as a unit in the vertical direction, i.e., Z direction, with the base 42 as the hub.

Therefore, the transfer arms 46, 48 can each move in the X, Z, R and θ direction. Further, the configuration of the common transfer mechanism 40 is not limited to the aforementioned structure having the transfer arms 46, 48 overlapping in the upper and lower two stage positions.

Moreover, installed at the other end of the X direction of the common transfer chamber 36 is an orienter 50 serving as a positioning mechanism for performing positioning of the wafer. The orienter 50 has a reference platform 52 rotated by a driving motor (not shown). The reference platform 52 rotates while the wafer W is mounted thereon. Installed at the outer periphery of the reference platform 52 is an optical sensor 54 for detecting the peripheral portion of the wafer W. The optical sensor 54 is composed of a linear lighting emitting device (not shown) having a certain length while the device is installed along the radial direction of the reference platform 52, and a photo detection device (not shown) disposed to face the corresponding lighting emitting device with the peripheral portion of the wafer interposed therebetween. The lighting emitting device irradiates a laser beam toward an end portion of the wafer and then the photo detection device detects a variance of detection condition. Based on the detection result, it is possible to determine the degree of eccentricity, the eccentric direction of the wafer W and the position of rotating direction, i.e., orientation, of, e.g., notches or orientation flats formed as a cutoff mark on the wafer W.

Further, installed at the other side of the lengthwise direction of the common transfer chamber 36 are multiple (three in this example) first transport auxiliary chambers 56A, 56B and 56C via openable/closable gate valves 58A, 58B and 58C, respectively. Installed in each of the first transport auxiliary chambers 56A, 56B and 56C are a pair of buffer mounting tables 60, 62 for temporarily mounting and standing by thereon the wafer W. Here, the buffer mounting table 60 near the common transfer chamber 36 is referred to as the first buffer mounting table while the buffer mounting table 62 on the opposite side is referred to as the second buffer mounting table. Installed between the buffer mounting tables 60 and 62 are transport arm mechanisms 64A, 64B and 64C having multi-joint arms capable of contracting, extending, revolving and elevating. Forks are installed at the front ends of the transport arm mechanisms 64A, 64B and 64C, so that the wafer W can be transported between the first and the second buffer mounting tables 60 and 62 by using a corresponding fork. Further, here, in order to carry out an efficient transfer of the wafer W, each of the buffer mounting tables 60 and 62 can hold two wafers W at the upper and the lower portion. In addition, installed at each of the other end of the first transport auxiliary chambers 56A to 56C are vessel body ports 68A, 68B and 68C having openable and closeable gate valves 66A, 66B and 66C, respectively. As illustrated in FIG. 2, at the leading end of the vessel body ports 68A, 68B and 68C, joint flanges 70 are formed. To a corresponding joint flange 70, a treatment subject receiving vessel body 72, which is a characteristic feature of the present invention, can be detachably joined. Here, since each of the vessel body ports 68A to 68C has the completely same structure, the vessel body port 68A is representatively is shown in FIG. 2. FIG. 2 provides a cross sectional view taken along line A-A in FIG. 1.

Further, installed in each of the first transport auxiliary chambers 56A to 56C are gas supply lines 74A, 74B and 74C respectively for introducing therein a certain gas such as an inactive gas including a N₂ gas or the like, if necessary. Further, installed in each of the first transport auxiliary chambers 56A to 56C are gas exhaust lines 76A, 76B and 76C respectively for vacuum pumping the inner atmosphere, if necessary. Accordingly, each of the first transport auxiliary chambers 56A to 56C has a loadlock device capable of repeating an atmospheric pressure and a vacuum atmosphere.

Further, installed respectively at each of the outside of the gate valves 66A to 66C of the vessel body ports 68A to 68C are port gas supply lines 78A, 78B and 78C for supplying therein a certain gas if necessary and port gas exhaust lines 80A, 80B and 80C for vacuum pumping as necessary. As a result of this, it is possible to control the pressure level in the joint space between each of the vessel body ports 68A to 68C and the treatment subject receiving vessel body 72.

A seal member 82 such as O-ring or the like is installed on each cross section of the joint flanges 70 (see FIG. 2) along the circumference direction thereof. As a result, the flange 70 is guaranteed to be sealed airtight to the treatment subject receiving vessel body 72 when they are put together.

Further, a vessel platform 84 (not shown in FIG. 1, see FIG. 2) is installed under the respective vessel body ports 68A to 68C such that the platform extends to the front ends of the ports. The vessel platform 84 is installed so that it can slide forward and backward when necessary. On the top surface of the vessel platform 84, the treatment subject receiving vessel body 72 can be mounted. In addition, installed on the top surface of the vessel platform 84 are a positioning groove 86 in slot form and an exhaust joint nozzle 88 facing upward, which also serves as a joint. The exhaust joint nozzle 88 is connected to a vacuum exhaust system 90.

Meanwhile, as shown in FIGS. 2 and 3, the treatment subject receiving vessel body 72 includes a thin vessel-shaped vessel main body 92 having one side thereof exposed. The vessel main body 92 is made of, e.g., aluminum or stainless steel. At the open side of the vessel main body 92, a joint port 96 having a gate valve 94 is formed. A joint flange 98 is formed at the cross section of the joint port 96. The joint flange 98 can be airtightly connected to the joint flange 70 (see FIG. 2) of the respective first transport auxiliary chambers 56A to 56C.

Installed in the vessel main body 92 is a treatment subject support member 100 for supporting the wafer W. Specifically, the treatment subject support member 100 includes, e.g., three support columns 102 made of quartz (only two are shown in FIG. 2) wherein the columns are disposed upright at different points along the wafer's circumference. Further, supporting ledge 104 installed at each of the support columns 102 toward the center of the circumference can support multiple wafers W, e.g., two in this example in the upper and lower stages. The number of wafers W to be held is not limited to two but can be one or more than two.

Further, multiple positioning projections 106 are projected downward on the lower surface of the bottom portion of the vessel main body 92. The positioning projections 106 are fitted in the positioning grooves 86 formed at the vessel platform 84, thereby positioning the vessel main body 92.

Further, installed at the bottom portion of the vessel main body 92 is an exhaust port nozzle 108, which is directed downward to exhaust the inner atmosphere of the vessel main body 92 and which also serves as a joint. The exhaust port nozzle 108 is detachably connected to the exhaust joint nozzle 88 of the vessel platform 84. As a result, the treatment subject receiving vessel body 72 can be transported as a single unit.

Meanwhile, referring back to FIG. 1, six processing chambers 110A to 110F are arranged in two rows and three columns in the processing unit 32. In each of the processing chambers 110A to 110F, same or different kinds of processes are performed on the wafer W. Further, with each of the processing chambers 110A to 110F., second transport auxiliary chambers 114A to 114F are linked up via each openable/closable gate valves 112A to 112F, respectively. Further, installed in each of the second transport auxiliary chambers 114A to 114F are transport arm mechanisms 116A to 116F having multi-joint arms capable of elevating, revolving, contracting and extending.

Further, similar to the structure of the first transport auxiliary chambers 56A to 56C, vessel body ports 120A to 120F having openable/closeable gate valves 118A to 118F are installed at the other ends of the second transport auxiliary chambers 114A to 114F. As illustrated in FIG. 4, a joint flange 122 is formed at each of the leading ends of the vessel body ports 120A to 120F. The treatment subject receiving vessel body 72 can be detachably connected to the corresponding joint flange 122. Here, since each of the vessel body ports 120A to 120F consists of the completely same configuration, the vessel body port 120F is representatively shown in FIG. 4. FIG. 4 is a cross sectional view taken along line F-F in FIG. 1.

Further, installed in each of the second transport auxiliary chambers 114A to 114F are gas supply lines 124A to 124F respectively for introducing therein a certain gas such as an inactive gas of a N₂ gas or the like as necessary. Further, installed in each of the second transport auxiliary chambers 114A to 114F are gas exhaust lines 126A to 126F respectively for vacuum pumping the inner atmosphere when necessary. As a result of this, each of the second transport auxiliary chambers 114A to 114F has a loadlock function capable of repeating an atmospheric pressure and a vacuum atmosphere.

Further, installed at the outside of the gate valves 118A to 118F of the vessel body ports 120A to 120F respectively are port gas supply lines 128A to 128F for supplying therein a certain gas when necessary and port gas exhaust lines 130A to 130F for vacuum pumping when necessary. As a result of this, it is possible to control the pressure level in the joint space between each of the vessel body ports 120A to 120F and the treatment subject receiving vessel body 72.

In addition, a seal member 132 such as O-ring or the like is installed on each cross section of the joint flanges 122 (see FIG. 4) along the circumference direction thereof. As a result, the flange 122 is guaranteed to be sealed airtight to the treatment subject receiving vessel body 72 when they are put together.

Further, a vessel platform 134 (not shown in FIG. 1, see FIG. 4) is installed under the respective vessel body ports 120A to 120F so that the platform extends to the front ends of the ports. The vessel platform 134 is installed so that it can slide forward and backward when necessary. On the top surface of the vessel platform 134, the treatment subject receiving vessel body 72 can be mounted. In addition, installed on the top surface of the vessel platform 134 are a positioning groove 136 in slot form and an exhaust joint nozzle 138 facing upward, which also serves as a joint. The exhaust joint nozzle 138 is connected to a vacuum exhaust system 140.

In addition, a vessel transfer unit 142 shown in FIG. 5 is installed in order to transport the treatment subject receiving vessel body 72 between each of the first transport auxiliary chambers 56A to 56C and each of the second transport auxiliary chambers 114A to 114F respectively.

Specifically, the vessel transfer unit 142 is composed of a guide rail 144 typically installed at the ceiling portion and a pair of support arms 146 moving along the guide rail 144. The pair of support arms 146 are designed so that they can expand and contract so that the treatment subject receiving vessel body 72 can be held therebetween. Further, the support arms 146 are connected to a moving body 150 via an extendable/contractible rod 148, wherein the moving body 150 is slidably supported on the guide rail 144. Further, the guide rail 144 is installed along the transfer path 152 illustrated in FIG. 1. Accordingly, as described above, the treatment subject receiving vessel body 72 can be transported to a certain location. Further, the vessel transfer unit is not limited to the aforementioned configuration but can be a robot type vessel transfer unit used, for example, in a machine shop. Further, the vessel transfer unit can be a vessel transfer unit, which uses a linear motor and a rail. In the end, the configuration does not matter as long as the vessel transfer unit is able to transfer the vessel body 72.

Hereinafter, a transfer method performed by using the above-described treating system 30 will be discussed.

FIG. 1 shows the configuration wherein the treatment subject receiving vessel body 72 is connected to the two first transport auxiliary chambers 56A and 56B and the four second transport auxiliary chambers 114A to 114C and 114F.

First, a general route of the wafer W will be discussed. The wafer is taken out from each of the cassette vessels C by the common transfer mechanism 40 and then transferred to the orienter 50. Next, the wafer is mounted on the reference platform 52 of the orienter 50, where its positioning is determined. The wafer of which positioning has been determined is received and held by the common transfer mechanism 40 and then transferred to the front of any one of the first transport auxiliary chambers, e.g., a first transport auxiliary chamber 56A. Then, after a pressure adjustment is performed, the gate valve 58A of the first transport auxiliary chamber 56A is opened so that the wafer can be held on the first buffer mounting table 60 in the first transport auxiliary chamber 56A. In the same manner, a second wafer to be processed is held on the mounting table 60.

At this time, if a processed wafer is on the first buffer mounting table 60, it is replaced with an unprocessed wafer so the processed wafer would be returned to the cassette C. In this way, when two unprocessed wafers are accommodated in the first transport auxiliary chamber 56A, the interior of the first transport auxiliary chamber 56A is vacuum pumped to carry out a pressure control.

Here, as illustrated in FIG. 2, in the treatment subject receiving vessel body 72 mounted on the vessel platform 84, when the vessel body is mounted thereon, the exhaust port nozzle 108 installed at the lower portion of the treatment subject receiving vessel body 72 gets connected with the exhaust joint nozzle 88 of the vessel platform 84. Further, the interior of the vessel main body 92 is vacuum pumped in advance to a certain pressure.

Further, when the vessel body 72 is connected to the vessel body port 68A of the first transport auxiliary chamber 56A, the sealed space 154 (see FIG. 2) formed between the vessel body port 68A and the joint port 96 of the vessel body 72 is occupied by clean air at atmospheric pressure. Therefore, the inner atmosphere of the sealed space 154 is vacuum pumped from the port gas exhaust line 80A, thereby controlling the inner pressure of the sealed space 154.

As a result of this, when the inner pressure levels of the first transport auxiliary chamber 58A, the sealed space 154 and the vessel body 72 are adjusted to an approximately equal pressure level, each of the gate valves 66A and 94 (see FIG. 2) is kept open. Further, by using the transport arm mechanism 64A in the first transport auxiliary chamber 58A, two unprocessed wafers W are transported and held on a treatment subject support member 100 in the vessel body 72. Further, only one wafer may be transported and mounted while leaving the other supporting ledge 104 unoccupied. At this time, if a processed wafer W is held on the treatment subject support member 100, the processed wafer W is firstly loaded into the first transport auxiliary chamber 58A and then the unprocessed wafer W is transported.

As above, when the unprocessed wafer W is completely loaded into the vessel body 72, each of the gate valves 66A and 94 is closed. Thereafter, air is introduced into the sealed space 154 via the port gas supply line 78A installed in the vessel body port 68A, thereby restoring the interior of the sealed space 154 to atmospheric pressure. Accordingly, the vessel body 72 can be physically separated from the vessel body port 68A. Further, by moving slightly the vessel platform 84 on which the vessel body 72 is mounted towards the direction of vessel body separation, the vessel body 72 is separated from the vessel body port 68A. At this time, the interior of the vessel body 72 is still maintained in a vacuum condition.

Next, by using a vessel transfer unit 142, which is installed on the ceiling portion as illustrated in FIG. 5, the vessel body 72 is transferred to, e.g., the second transport auxiliary chamber 114F of the processing chamber 110F.

Here, the unprocessed wafer W is unloaded towards the second transport auxiliary chamber 114F in reverse order of the prior description with respect to the first transport auxiliary chamber 56A. Namely, as shown in FIG. 4, by sliding the vessel platform 134 towards the joining side (left side in the drawing), the vessel body port 120F of the second transport auxiliary chamber 114F gets connected to the joint port 96 of the vessel body 72, thereby forming the sealed space 156. Thereafter, by vacuum pumping the sealed space 156 from the port gas exhaust line 130F, the atmospheric pressure of the sealed space becomes approximately equal to the inner pressure of the second transport auxiliary chamber 114F which has been kept in a vacuum condition in advance. Next, both gate valves 118F and 94 are opened and, thus, the interior of the vessel body 72 communicates with the interior of the second transport auxiliary chamber 114F so that the unprocessed wafer W is transported from the vessel body 72 into the second transport auxiliary chamber 114F.

Here, if the processed wafer W is in the second transport auxiliary chamber 114F, only one, not two, unprocessed wafer W may be accommodated in the vessel body 72 and then transported while having a free space for mounting a processed wafer. Otherwise, a buffer mounting table may be separately installed in the second transport auxiliary chamber 114F. Otherwise, the transport arm mechanism 116F in the second transport auxiliary chamber 114F may be a two peak type arm mechanism having the same structure as the common transfer mechanism 40. Regardless, a transfer set up which will not cause a deadlock while exchanging a processed wafer with an unprocessed wafer is used.

As described above, the unprocessed wafer W is loaded into the second transport auxiliary chamber 114F. Meanwhile, the processed wafer W is accommodated in the vessel body 72. Thereafter, the sealed space 156 is restored to atmospheric pressure, and the vessel body 72 is separated from the vessel body port 120. In addition, the vessel body 72 housing the processed wafer W is returned to, e.g., the initial first transport auxiliary chamber 56A. Further, the vessel body 72 may be vacuum pumped by the vacuum exhaust unit 140 even when the vessel body 72 is mounted on the mounting table 134.

As described above, the vessel body 72 can always be maintained in a vacuum atmosphere. Accordingly, it is possible to prevent the formation of a native oxide or the like on the wafer surface.

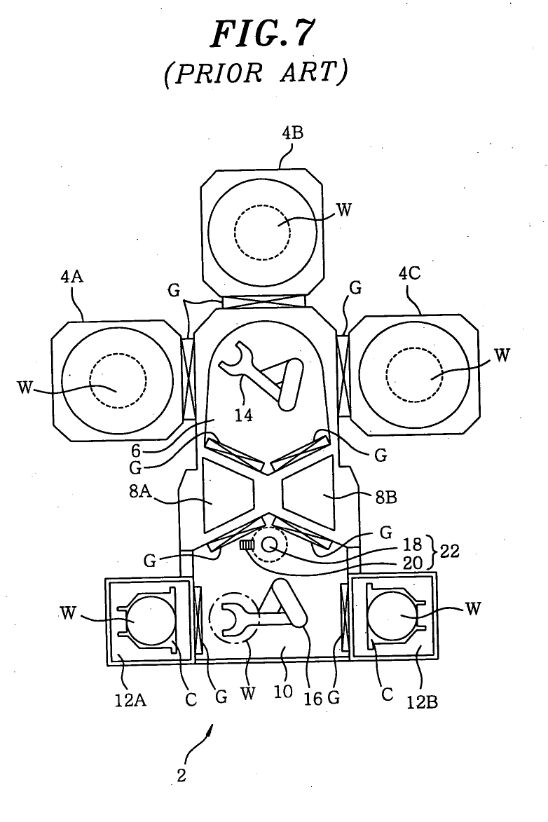

Further, since the vessel body 72, which can be sealed airtight and is portable, is used, it is possible to eliminate the conventionally required large-sized common transfer chamber (corresponding to the first transfer chamber 6 of FIG. 7), i.e., so-called transfer chamber.

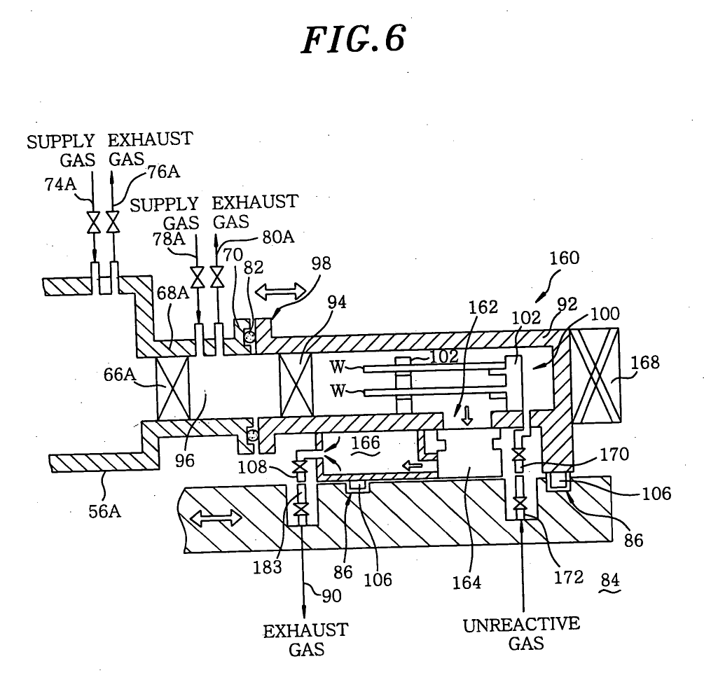

Further, in this embodiment, although a case where the interior of the vessel body 72 is always maintained in a vacuum condition has been discussed, it is not limited thereto. The vessel body 72 may be changed with an inactive gas such as a N₂ gas or Ar gas or the like. For example, as will be described later with reference to FIG. 6, a gas supply port may be installed at the bottom portion of the vessel body 72 and also a gas supply joint nozzle at both vessel platforms 84 and 134 so that N₂ gas or Ar gas is fed into the vessel body 72 as necessary.

In order to maintain a high vacuum level in the treatment subject receiving vessel body 72, the configuration illustrated in FIG. 6 can be used. FIG. 6 shows a modified example of the treatment subject receiving vessel body. With respect to the configuration illustrated in FIG. 6, its discussion is omitted while parts identical to those in FIG. 2 will be assigned the same reference numerals.

In the bottom portion of the treatment subject receiving vessel body 160 shown in FIG. 6, a gas exhaust port 162 having a relatively large aperture is formed. The gas exhaust port 162 is directly connected to a vacuum pump 164 such as turbomolecular pump or the like. Further, a backing space 166 having a relatively large capacity is adjacently installed at the exhaust side of the vacuum pump 164. Accordingly, the pressure of the exhaust side of the vacuum pump 164 can be lowered as low as possible.

Further, the backing space 166 is connected to the exhaust port nozzle 108 having the same structure as illustrated in FIG. 2. Moreover, installed at the rear portion of the vessel main body 92 of the vessel body 160 is a rechargeable pump power source 168 for rotating the vacuum pump 164. The pump power source 168 includes a pump controller, which is not shown, and is capable of rotating the vacuum pump 164 when necessary.

Further, installed in the bottom portion of the vessel main body 92 is a gas supply port 170 for supplying required gases into the vessel main body 92. A gas supply joint nozzle 172 facing the gas supply port 170, which functions as a joint and is detachably connected to the gas supply port 170, is installed in the vessel platform 84. As a result, it is possible to supply an inactive gas such as a N₂ gas or an Ar gas or the like into the vessel main body 92 as necessary. Further, the gas supply port 170 and the gas supply joint nozzle 172 can be installed at the aforementioned apparatus example as illustrated in FIG. 2.

Further, it is possible to install a power joint for supplying power to the pump power source 168 in the vessel platform 84.

Further, the structure of each of the vessel platform 134 installed at each of the second transport auxiliary chambers 114A to 114F can be identical to that of the vessel platform 84 illustrated in FIG. 6.

In the aforementioned treatment subject receiving vessel body 160, it is possible to supply an inactive gas as necessary. Further, since vacuum pumping can be performed in two stages by employing the vacuum pump 164 composed of a turbomolecular pump and a vacuum pump (not shown) of the vacuum exhaust system 90, a higher vacuum level in the vessel body 160 can be maintained.

Especially, in case the vessel body 160 is separated from the vessel platform 84 and then individually transported, the vacuum pump 164 is always rotated by power from the pump power source 168 installed therein as a unit so that the inner atmosphere of the vessel main body 92 is exhausted to the backing space 166. Accordingly, it is possible to maintain a higher vacuum level in the vessel body 160.

Further, as described above, when the vessel body 160 is mounted on the vessel platform 84, the inner atmosphere of the backing space 166 is vacuum pumped from the vacuum exhaust system 90 to the exterior of the system.

Further, in the aforementioned apparatus, the common transfer chamber 36 having therein the common transfer mechanism 40 is installed. However, by omitting the common transfer chamber 36, a wafer may be directly loaded from each of the loading/unloading ports 38A to 38C into each of the first transport auxiliary chambers 56A to 56C respectively.

Further, even though the semiconductor wafer W has been described as the example of a treatment subject, without being limited thereto, the present invention can be applied to a glass substrate, an LCD substrate or the like.

While the invention has been shown and described with respect to the preferred embodiments, it will be understood by those skilled in the art that various changes and modifications may be made without departing from the spirit and scope of the invention as defined in the following claims.

1. A treatment subject receiving vessel body, comprising:
a vessel main body capable of being carried;
a treatment subject support member, disposed in the vessel main body, for supporting a plurality of treatment subjects;
a joint port formed at one side surface of the vessel main body and communicating with an interior of the vessel main body;
an openable and closable gate valve installed at the joint port; and
an openable and closable exhaust port disposed in the vessel main body to exhaust the vessel main body,
wherein the vessel main body becomes sealed airtight when the gate valve and the exhaust port are closed.

2. The treatment subject receiving vessel body of claim 1, wherein the vessel main body includes an exhaust opening; a vacuum pump connected to an exhaust opening; and a backing space connected to an exhaust side of the vacuum pump, the exhaust port being installed at the backing space.

3. A treating system comprising:
the treatment subject receiving vessel body described in claim 1;
a first transport auxiliary chamber having at one side thereof a vessel body port to which the treatment subject receiving vessel body is connected and having therein a transport arm mechanism for transporting a treatment subject;
a second transport auxiliary chamber having at one side thereof a vessel body port to which the treatment subject receiving vessel body is connected and having therein a transport arm mechanism for transporting the treatment subject; and
a vessel body transfer unit for transporting the treatment subject receiving vessel body between the first transport auxiliary chamber and the second transport auxiliary chamber.

4. The treating system of claim 3, further comprising:
a processing chamber for performing a process on the treatment subject, and
wherein the second transport auxiliary chamber is located such that another side thereof is adjacent to the processing chamber and the transport arm mechanism therein is capable of transporting the treatment subject between the processing chamber and the treatment subject receiving vessel body.

5. The treating system of claim 3, further comprising:
a loading/unloading port onto which a cassette vessel containing plural treatment subjects is placed, and
wherein the first transport auxiliary chamber is located such that another side thereof is adjacent to the loading/unloading port, and the transport arm mechanism therein transports the treatment subject between the cassette vessel and the treatment subject receiving vessel body.

6. The treating system of claim 3, further comprising:
a loading/unloading port onto which a cassette vessel containing plural treatment subjects is placed; and
a common transfer chamber installed adjacent to the loading/unloading port,
wherein the first transport auxiliary chamber is located such that another side thereof is adjacent to the common transfer chamber and the transport arm mechanism therein transports the treatment subject between the cassette vessel and the treatment subject receiving vessel body.

7. The treating system of claim 6, wherein the common transfer chamber includes a positioning mechanism for performing positioning of the treatment subject.

8. The treating system of claim 3, wherein the vessel body port of the first transport auxiliary chamber is provided with an openable and closable gate valve, and the vessel body port of the second transport auxiliary chamber is also provided with an openable and closable gate valve.

9. The treating system of claim 8, wherein the first transport auxiliary chamber is provided with a gas exhaust line; the second transport auxiliary chamber is also provided with a gas exhaust line; a port gas supply line and a port gas exhaust line are installed outside the gate valve of the vessel body port of the first transport auxiliary chamber; and a port gas supply line and a port gas exhaust line are also installed outside the gate valve of the vessel body port of the second transport auxiliary chamber.

10. The treating system of claim 9, wherein the first transport auxiliary chamber is provided with a gas supply line and the second transport auxiliary chamber is also provided with a gas supply line.
